(19) United States
(12) Patent Application Publication
(10) Pub. No.: US 2024/0185054 A1
(43) Pub. Date: Jun. 6, 2024

(54) COMBINATORIAL OPTIMIZATION PROBLEM SIZE REDUCTION USING MACHINE LEARNING IN EDGE ENVIRONMENTS

(71) Applicant: Dell Products L.P., Round Rock, TX (US)

(72) Inventors: Miguel Paredes Quiñones, Campinas (BR); Ítalo Gomes Santana, Rio de Janeiro (BR); Vinicius Michel Gottin, Rio de Janeiro (BR)

(21) Appl. No.: 18/049,183

(22) Filed: Oct. 24, 2022

(51) Int. Cl. G06N 3/08; G06F 17/11; G06N 3/04

(52) U.S. Cl. CPC G06N 3/08; G06F 17/11; G06N 3/0454

(57) ABSTRACT

Reducing the size of combinatorial optimization problems is disclosed. To reduce the size of a combinatorial optimization problem, empirical data is generated by generating results and empirical distributions of relevant input features. A model is trained to output encoded distributions may minimizing a loss between the empirical distributions and the machine learning generated distributions. Inputs are sampled from the encoded distribution, which results in a smaller size input and a smaller size combinatorial optimization problem. The reduced size combinatorial optimization problem can be solved at an edge node rather than a central node its solution can used for operational purposes as long as the solution is feasible.

### FIELD OF THE INVENTION

Embodiments of the present invention generally relate to combinatorial optimization problems (COP) and logistics operations. More particularly, at least some embodiments of the invention relate to systems, hardware, software, computer-readable media, and methods for solving combinatorial optimization problems in the context of constrained computing resources.

### BACKGROUND

Combinatorial optimization problems generally relate to situations where there is a desire to find an optimal solution from a set of possible solutions. Typical combinatorial optimization problems include the travelling salesman problem (TSP), the minimum spanning tree problem (MST), and bin packing problems. For example, it may be necessary for a robot to pick up objects in a warehouse and deliver the objects to various destinations. The combinatorial optimization problem presented in this case is to identify the best route or tour for the robot. In other words, of the set of possible tours, which tour is an optimal tour (e.g., optimal in terms of cost).

Many combinatorial optimization problems are NP-hard (nondeterministic polynomial time) problems. The difficulty of solving combinatorial optimization problems at, for example, the robot, is that the computing resources of the robot are often limited and solving a combinatorial optimization problem may not be practical. The time required to solve a combinatorial optimization problem increases exponentially as the size of the combinatorial optimization problem increases.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a combinatorial problem;

FIG. 1B discloses aspects of encoding a solution to a combinatorial problem as a permutation of its elements;

FIG. 1C discloses additional aspects of encoding a solution to a combinatorial problem as the incidence of its elements;

FIG. 2 discloses aspects of an environment in which each edge node attempts to solve a particular instance of a combinatorial problem;

FIG. 3 discloses aspects of collecting data in an environment;

FIG. 4A discloses aspects of solving a combinatorial problem;

FIG. 4B discloses aspects of training a machine learning model configured to reduce a size of a combinatorial problem;

FIG. 4C discloses additional aspects of training a machine learning model configured to reduce a size of a combinatorial problem;

FIG. 5 illustrates aspects of deploying a trained model to an edge node and solving reduced size combinatorial problems locally;

FIG. 6 discloses aspects of reducing a size of a combinatorial problem; and

FIG. 7 discloses aspects of a computing device, system, or entity.

### DETAILED DESCRIPTION OF SOME EXAMPLE EMBODIMENTS

Embodiments of the present invention generally relate to logistics, logistics operations and combinatorial optimization problems (COPS). More particularly, at least some embodiments of the invention relate to systems, hardware, software, computer-readable media, and methods for reducing a size of a combinatorial optimization problem in environments including edge environments.

Devices operating in edge environments may have difficulty solving combinatorial optimization problems efficiently and quickly due to the lack of sufficient computational resources. Embodiments of the invention are configured to solve combinatorial optimization problems using edge computing and machine learning.

When there is a need to solve a combinatorial optimization problem, or to solve multiple combinatorial optimization problems, edge devices may coordinate with a central node (e.g., an edge-based computing or a cloud-based system) that has the resources needed to solve these types of combinatorial organizational problems. However, when multiple edge devices or nodes are sending combinatorial optimization problems to the central node, a bottleneck may be created and there may be a delay in providing the solutions to the combinatorial optimization problems.

Embodiments of the invention relate to an edge-based architecture or framework for solving combinatorial optimization problems. The framework generally includes a training phase and a deployment phase. During the training phase, a machine learning model that allows a size of a combinatorial optimization problem to be reduced is trained. The machine learning models are trained to identify the manner in which the size of the combinatorial problems can be reduced. This may include reducing the size of an input space or fixating some of the problem's decision variables.

When the size of the combinatorial problem is sufficiently reduced, the computing resources of the edge devices may be sufficient to solve the reduced size combinatorial problem. This reduces reliance on a central node, reduces delays associated with transmitting the combinatorial problems to the central node and waiting for a response or a decision, and the like. Embodiments of the invention may also circumvent situations where non-feasible solutions result from use of the machine learning model.

Combinatorial optimization problems belong to a class of challenging problems that require efficient optimization methods to address the burden in solving the combinatorial optimization problems, especially in the presence of hard constraints, multiple objectives, and at large scale. Embodiments of the invention use machine learning to provide tools that can enhance decision making processes within these optimization methods using data such as telemetry data.

In one example, machine learning models are used to reduce the size of combinatorial optimization problems in a distributed environment. The devices operating in the environment may include computing resources (processor, memory, and networking hardware). These devices and/or their computing resources are referred to as nodes or edge nodes. A central node may include more powerful computing resources (e.g., multiple server computers) and may exist in an edge system on in a cloud system.

In one example, a set of nodes may be able to solve reduced instances of combinatorial optimization problems and a central node is able to solve entire instances of combinatorial optimization problems.

In one example, a problem instance of a combinatorial optimization problem may be provided to or be presented to nodes in an environment. Each node is provisioned with a machine learning model that has been trained on historical and/or synthetic data of the same/similar problem. This may guide an encoding process of transforming the original instance of the combinatorial optimization problem into a reduced size combinatorial optimization problem.

In one example, reducing the size may include reducing the number of elements of the combinatorial optimization problem. Reducing the size of the combinatorial optimization problem may also including keeping the same number of elements while pruning some of the relationships or value ranges of elements of the combinatorial optimization problem. Pruning some of the relationships or limiting value ranges reduce the solution space, which can significantly reduce computation time.

However, when the reduced combinatorial optimization problem cannot be solved at the edge node (e.g., non-feasible solutions are generated), the central node may be used to solve the original combinatorial optimization problem. This advantageously mitigates communication costs (e.g., only a few of the edge nodes may require a solution from the central node).

Embodiments of the invention may be implemented in various environments such as warehouses, factories, geographical areas, or the like. For example, a combinatorial optimization problem may include optimizing tours for a set of autonomous vehicles (e.g., edge nodes) in a warehouse scenario. A tour is tailored for each node and each tour involves a task of picking up and delivering items scattered in the warehouse at minimum travel cost.

As a practical example, a combinatorial optimization problem may be to optimize tours for a set of autonomous vehicles (i.e., edge nodes) in a warehouse scenario. Each tour involves the task of picking and delivering items scattered in the warehouse at minimum travel cost. Historical tours are used to train a machine learning model that outputs decisions in which common fragments of tours are merged into a single point.

Each of the nodes, using an encoding process, combines the original problem instance and the outputs of this machine learning model into a reduced version of the original problem that is suitable to be solved within the node itself. This has several benefits and advantages. This may reduce operational costs, improve efficiencies in executing demanding processes, and mitigate or reduce computational requirements while providing feasible and quality solutions for combinatorial optimization problems in various domains.

Generating a reduced size combinatorial optimization problem allows edge nodes that have comparatively constrained resources to generate a solution locally. Further the computational effort may be distributed amount the edge nodes. If non-feasible solutions are generated, the combinatorial optimization problem can still be solved at the central node, even if there is some delay and communication overhead.

Because the combinatorial optimization problem is reduced, solutions may not be optimal solutions. Embodiments of the invention are advantageous where a guarantee of solution optimality is not required.

In one example, each node in an environment may need to solve a combinatorial optimization problem. The combinatorial optimization problem O is defined in a standard form as follows:

$$0 : {min}_{x} f ( x )$$

$$x ∈ Ω ⋂ {\{ 0 , 1 \}}^{n} .$$

In this example, Ω is the domain of the optimization problem, ƒ(x) is the objective function and x is a set of decision variables.

Conventionally, a node (ε) may send an encoded specification to an edge server (e.g., a central node ( [symbol] )) and wait for an optimal solution to the problem O. As previously stated, this approach is not scalable because sending multiple encoded specifications from multiple nodes over a network to the central node may create a bottleneck. Further, the resources available for the combinatorial optimization problem O may depend on applications running in the central node, resource availability, and time requirements to generate the optimal solution.

More generally, the complexity of solving a combinatorial optimization problem is difficult because the number of solutions increases exponentially as the size of the problem increases. This makes solving hard combinatorial optimization problems difficult, even for small problem instances. In other words, these are NP-hard problems.

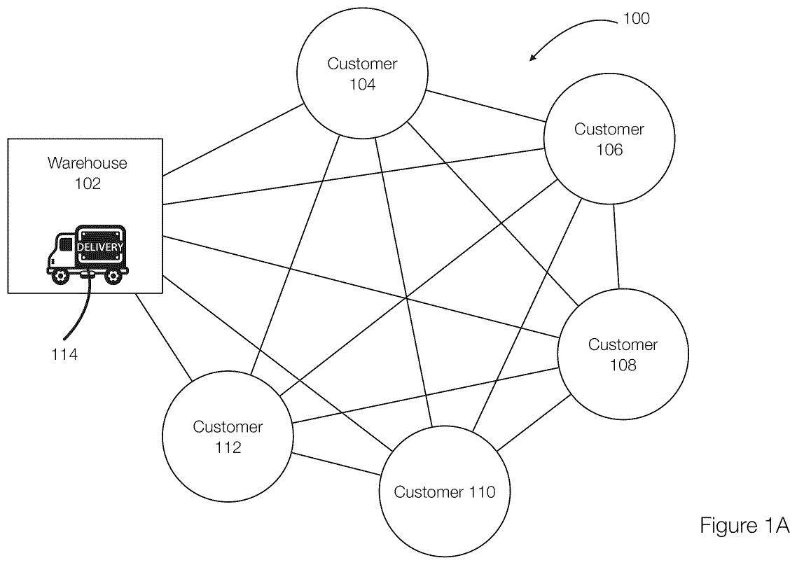

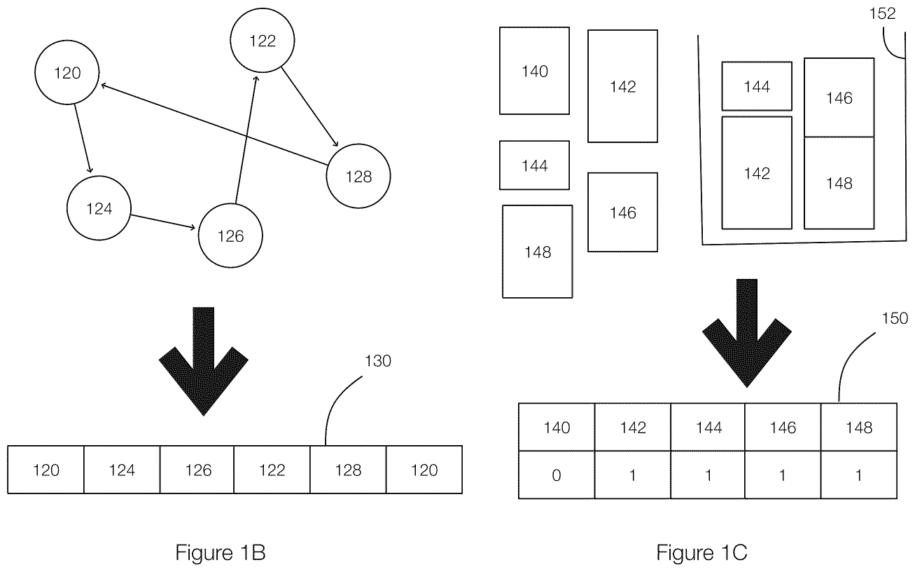

For example, a common logistics problem relates to using one vehicle to deliver goods to customers at a minimum travel cost. FIG. 1A discloses aspects of a combinatorial optimization problem. In the combinatorial optimization problem 100, a delivery vehicle 114 needs to deliver goods to 5 customers 104, 106, 108, 110, and 112. The tour starts and ends at the warehouse 102. The number of possible tours is 6! (720 tours) under these requirements. If the combinatorial optimization problem 100 grows to 100 customers and one warehouse 102, the number of possible tours increases to number with more than 150 digits. This is an example of a Traveling Salesperson Problem (TSP), which is a special case of a more general problem known as Capacitated Vehicle Routing Problem (CVRP). The combinatorial nature present in these problems and other hard combinatorial optimization problems makes them challenging even for the more powerful arrays of computers.

Combinatorial optimization problems may be defined by discrete decision variables and their elements, resulting in a finite number of solutions encoded by arrangements of elements, sets, or permutations. In one example, an encoding is used to translate a problem solution to a more convenient representation for the combinatorial optimization method.

FIG. 1B discloses aspects of encoding a solution as a permutation of its elements while FIG. 1C discloses aspects of encoding a solution as an incidence array of its elements. FIG. 1B illustrates nodes 120, 122, 124, 126 and 128. In this example, a solution to the combinatorial optimization problem of starting from a node, visiting all other nodes, and returning to the starting node is illustrated. An example tour goes from node 120 to node 124, to node 126, to node 122, to node 128, and returns to the node 120. This solution can be encoded as an encoding 130. This is an example of a permutation-based solution.

Thus, the order of visited nodes, which starts and finishes at node 120, is expressed by a permutation of all nodes.

FIG. 1C illustrates an example of a bin packing problem, which is another example of a combinatorial optimization problem. In the problem of FIG. 1C, an example encoding 150 is illustrated to represent which subset of the elements 140, 142, 144, 146, and 148 are included in a bin 152. The encoding includes a 1 for included in the bin 152 and a 0 for not included in the bin, thus, the incidence of the solution elements. In this specific solution encoding, the elements 142, 144, 146 and 148 are included in the bin 152.

Embodiments of the invention may train a machine learning model when performing combinatorial optimization problem related operations, which may include generating a reduced size combinatorial optimization problem and solving the reduced size combinatorial optimization problem.

Neural diving is an example of machine learning and may be employed in Conditional Generative Adversarial Neural Networks (cGAN) to reduce the integer variable space by giving partial values for some sets of integer variables. This technique recognizes the distribution of probabilities of partial assignments of the combinatorial optimization problem.

Then the probability coming from the output of the cGANs and its corresponding values in the expected distribution are used to fix some variables by determining a threshold or limit for those variables. One advantage of this technique is the possibility in some variables that have high probabilities in appearing in the optimal solution, allowing that some constraints can be eliminated or simplified in order to divide the original combinatorial optimization problem in subproblems.

In one example, the machine learning model or cGAN is trained using the following Energy function:

$$E ( x , p ) = \{ \begin{matrix}f ( x ) & if x is feasible , \\ ∞ & otherwise .\end{matrix}$$

In this example, ƒ(x) is an objective function of the combinatorial optimization problem, ƒ(x) is the objective function of the combinatorial optimization problem and P are the parameters of the combinatorial optimization problem.

This allows the normalized conditional distribution to be defined as follows:

$$p ( x , P ) = \frac{{e}^{- E ( x ; P )}}{{\sum }_{{x}^{′}} {e}^{- E ( {x}^{′} ; P )}} .$$

In a minimization scheme, this suggests that solutions with lower objective functions have better probabilities of happening. The learning task is to approximate p(x|P) using a model such as a cGAN.

Embodiments of the invention are configured to reduce a domain of combinatorial optimization problems using a machine learning model in an environment that includes a central node and edge nodes. Generally, this includes giving optimal solutions of a combinatorial optimization problem O for training a machine learning model M to induce a smaller version of O called O′. Each reduced-size combinatorial optimization problem O′ may be solved within or using the resources of an edge node.

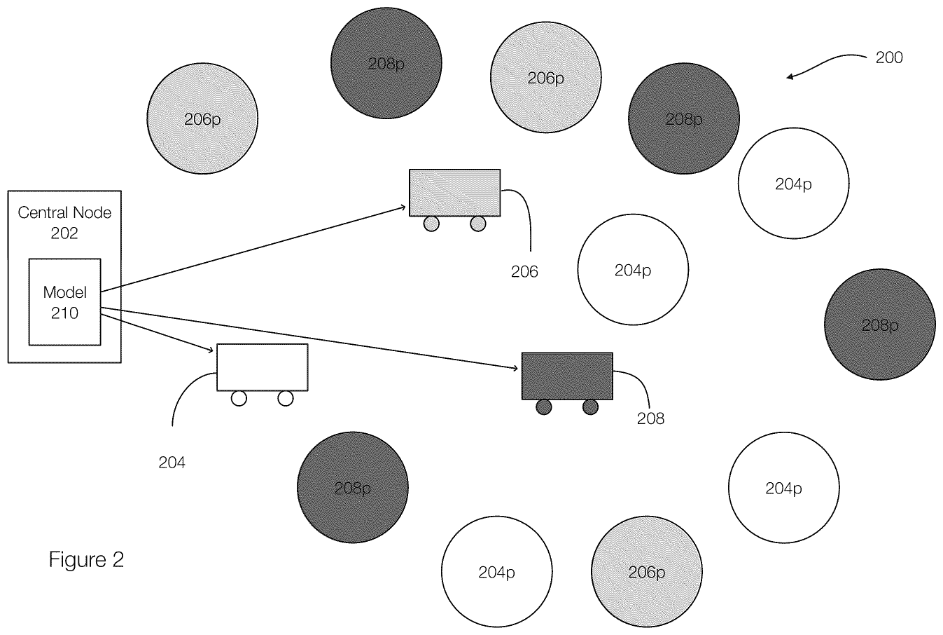

FIG. 2 discloses aspects of an example combinatorial optimization problem (e.g., a TSP) that often arises in logistics contexts. In the environment or system 200, the combinatorial optimization problem is to determine a route for each of the edge nodes 204, 206, and 208 in which the edge nodes 204, 206, and 208 collect a set of same-colored parcels 204p, 206p, or 208p at minimum travel costs. Each node thus has a different instance of the same combinatorial optimization problem.

In the example of FIG. 2, each of the edge nodes 204, 206, and 208 may solve a particular instance of the combinatorial optimization problem. Because the edge nodes 204, 206, and 208 are collecting different parcels at different locations, the problem instances are similar, but not necessarily identical. However, the same model may be used to reduce the size of the combinatorial optimization problem.

In one example, a central node 202 trains and deploys a model 210 to the edge nodes 204, 206, and 208. Once the model 210 is deployed to the edge nodes 204, 206, and 208, the combinatorial optimization problem instances can be reduced in size at the nodes in one example using the model 210 and solved at the respective edge nodes 204, 206, and 208.

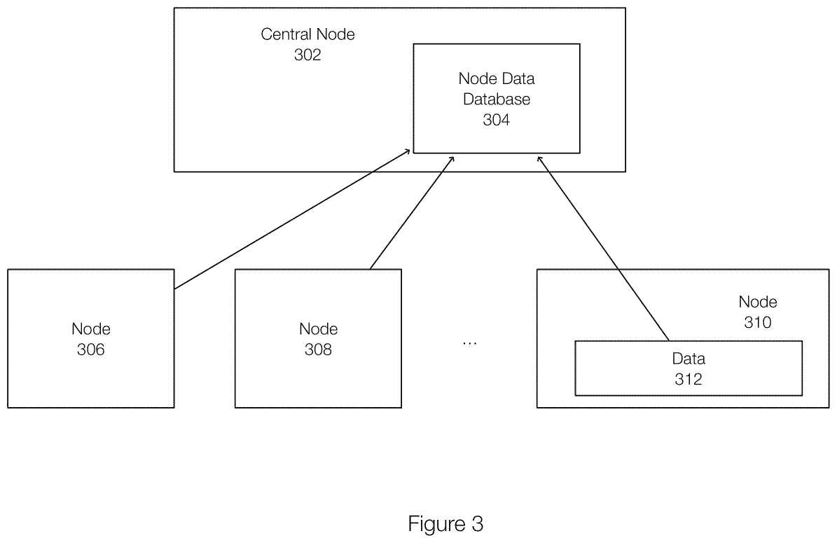

FIG. 3 discloses aspects of gathering data in preparation for training a model. In one example, the central node 302 ( [symbol] ) is associated with edge nodes, represented by nodes 306, 308, and 310 (nodes ε₁, ε₂, . . . , εᵢ). Each of the nodes 306, 308, and 310 may be associated with data that is transmitted to the central node 302 and stored in a node data database 304 ( [symbol] ). The data 312 represents data (Iᵢ) of the node 310.

More specifically, the data 312 collected by the node 310 may include, by way of example, sensor data, positioning data, telemetry data, global information (e.g., a map of roads and associated travel times, etc.), or the like. The data collected may be domain dependent and have the same features. The nodes 306 and 308 may collect similar data that is transmitted to and stored in the node data database 304.

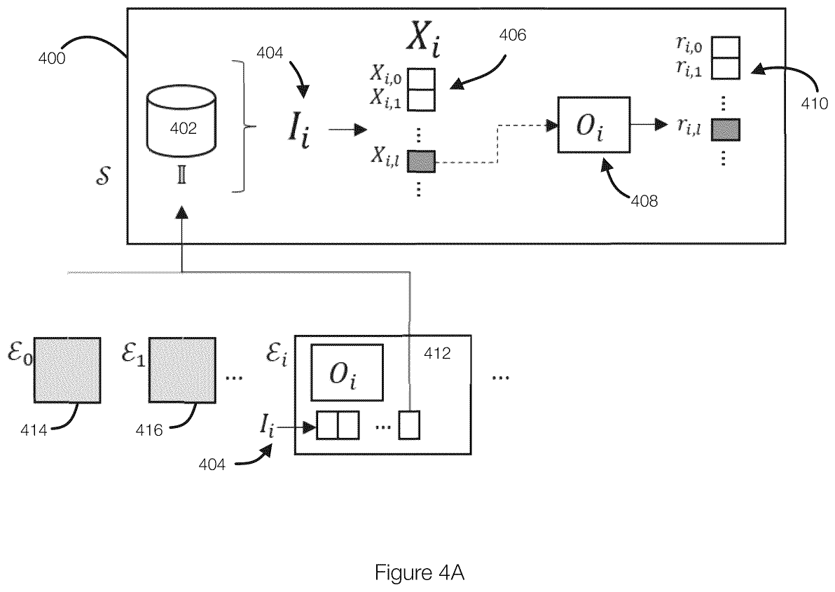

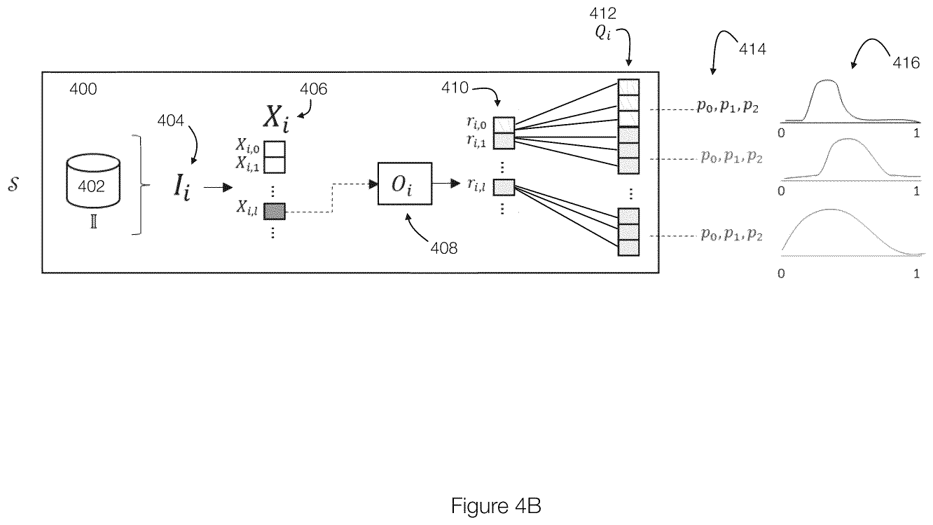

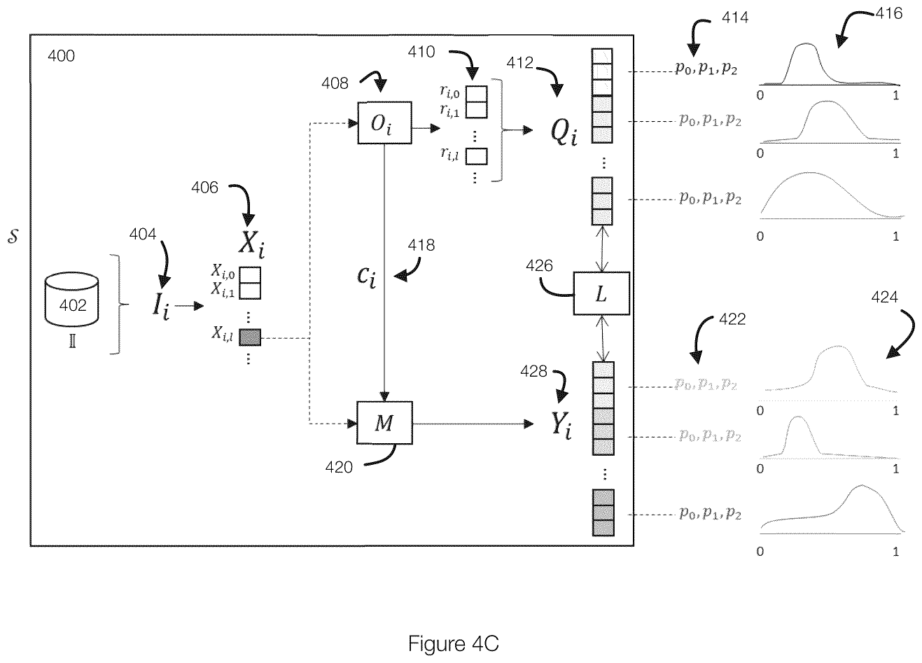

FIG. 4A discloses aspects of generating empirical results to a combinatorial optimization problem. As illustrated in FIG. 4A, information 404 from a node 412 is stored in a database 402 along with data from other nodes in the environment. In this example, inputs X can be derived from information I. In this example and for the problem 200 illustrated in FIG. 2, the information 1404 may be processed to extract a graph of parcels and their positions. This is an example of input X. This may be performed for each of the nodes 412, 414, and 416. With regard to the node 414 (node εᵢ) and the problem Oᵢ, a set of inputs 406 are derived from the information 404, where (Iᵢ ∈ [symbol] ).

In this example, the input Xᵢ={X_{i,0}, X_{i,1}, . . . , X_{i,l}, . . . }, where l is an index of a problem instance of model Oᵢ. In other words, each X_{i,l} is a graph including a new valid input to the combinatorial optimization problem, which may be a TSP for example. The solution 410 defines r_{i,l} to be an optimal solution (i.e., minimal travel cost solution) of instance l of the combinatorial optimization problem O.

FIG. 4A illustrates that the combinatorial optimization problem is solved at the central node 400. More specifically, during a training stage or phase, Oᵢ is solved with X_{i,l} at the central node 400. This allows empirical data to be generated and later used in training the model.

Embodiments of the invention are not restricted to solving a combinatorial optimization problem that is applicable to a single edge node. If the combinatorial optimization problem Oᵢ is applicable and relevant to other edge nodes εⱼ, εₖ, then the input Xᵢ can be extracted from or generated from the union of their data: Iᵢ∪Iⱼ∪Iₖ.

In the context of the problem 200 shown in FIG. 2, this suggests that the nodes 204, 206, and 208 (e.g., delivery vehicles) share an operational context. However, Iᵢ may be sufficiently representative and no aggregation of data from multiple edge nodes is needed. In the context of the problem 200 of FIG. 2, this suggests that the data collected by a particular node (e.g., the node 204) is sufficient to determine reasonable scenarios for the combinatorial optimization problem applied to other nodes.

If multiple combinatorial optimization problems are each applicable to a set of edge nodes, these problems may be considered separately and the process illustrated in FIG. 4A may be performed separately for each node and a singular context.

FIG. 4B discloses additional aspects of training a machine learning model and more particularly for preparing to train a model. As previously stated, solving Oᵢ using input X_{i,l} may be difficult to perform on an edge node because of limited resources, the need for a quick response, or other logistics reasons. Embodiments of the invention thus relate to obtaining a machine learning model that can encode Xᵢ into a distribution Yᵢ from which it will be possible to approximate solutions to Oᵢ with high probability.

Using the empirical results 410, which are solutions to the input 406, a distribution of decision variables of the combinatorial optimization problem that generated the optimal results is obtained. As illustrated in FIG. 4B, an empirical distribution Qᵢ 412 defines parameters of the distributions of the decision variables of X_{i,l} that generated the optimal results. In this example, the distribution Qᵢ 412 includes three parameters 414 p₀, p₁, p₃ that define a distribution 416 for each feature of the combinatorial optimization problem. This is possible because a function relating the outputs 412 of the optimization process to the input decision variables is known. In the present example, the solution r_{i,j} includes a route, which can be related to the input X_{i,l} as an indication of which edges belong to the optimal solution. Once the distribution Qᵢ 412 is obtained, the distribution 412 Qᵢ is considered as a ground truth distribution of features of the combinatorial optimization problem.

FIG. 4C discloses aspects of training a machine learning model after the empirical distribution 412 has been determined. Thus, FIG. 4C builds from the description of FIGS. 4A and 4B.

In this example, a loss function 428 determines a difference between the conditional distribution 428 Yᵢ generated by the model 420 and the empirical distribution 412 Qᵢ. The model 420 is trained to minimize a difference between results obtained with the original data Xᵢ by sampling on the original problem 408 and the results obtained with the encoded distributions 428.

The model 420 is trained using the input 406 and a codification cᵢ 418 of the combinatorial optimization problem 408. The codification 418 is input to the model 420. The distribution 428 output by the model 420 includes the parameters 422, which correspond to the parameters 414 and have a corresponding distribution 424. Thus, the model 420 is trained to generate a conditional distribution 428 based on the input 406 and the codification 418. Once the model 420 is trained, the model 420 may be deployed to the edge nodes.

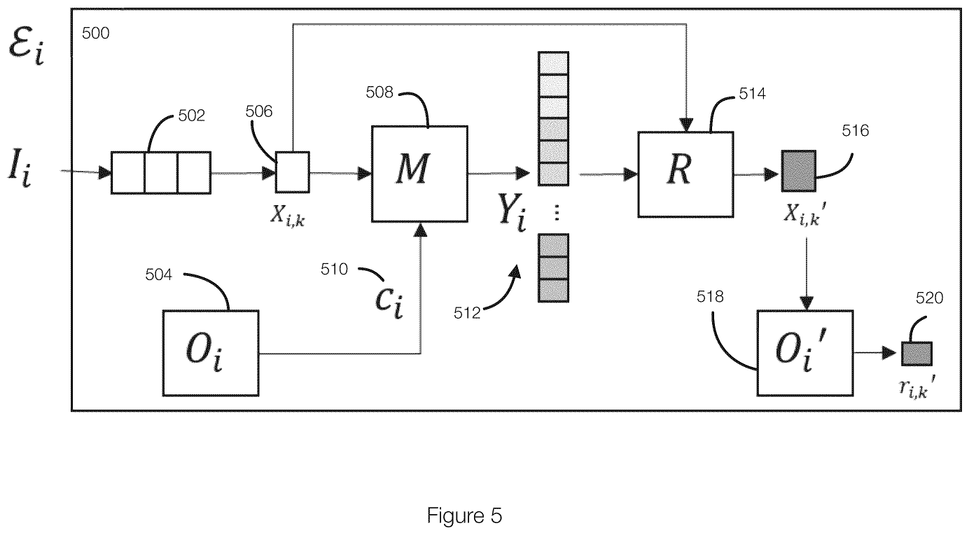

FIG. 5 discloses aspects of deploying and operating a trained model at edge nodes. In FIG. 5, a model 508 has been deployed to an edge node 500. Information 502 from the node is analyzed or processed to generate the input data 506. As previously stated, the input data 506, which may be generated from the information 502, may be a graph. The graph or input 506 may be input to the model 508 along with a codification 510 of the problem 504. The graph 506 may also be input to a sampling process 514.

The input 506 and the codification 504 may define a large instance of the combinatorial optimization problem 504. The model 508 outputs an encoded distribution 512. The probability distribution 512 is sampled by a sampling process 514 to generate an input 516 (X_{i,k}′). The input 516 is a valid input to the problem 518 (Oᵢ′) which is subject to the same context, but with a smaller search space. The problem 518 may be further partitioned or reduced in size by fixating some of the decision variables.

Because the problem 518 is a smaller instance of the problem 504, the node 500 may have the computing resources needed to solve the problem 518 using the input 516. The output 520 may be a solution, even if not an optimal solution, to the problem 504 or the reduced size problem 518.

If the output 520 is not a feasible solution, the original input 506 may be sent to a central node. The central node may provide an optimal solution by solving Oᵢ with X_{i,k}. The resulting optimal solution r_{i,k} is transmitted back to the node 500. The optimal solution may be used by the node rather than the solution 520 when the solution 520 is not feasible.

In some examples, the model 508 may be retrained and the central node and redeployed to the node 500 (and to other edge nodes). More specifically, the central node may store examples of non-feasible solutions and periodically assess whether the frequency or volume of infeasible solutions is above a threshold. For example, if the model 508 is generating more than a negligibly acceptable level of non-feasible solutions, the model 508 may be retrained.

The central node may collect a set of input X̅ᵢ that generated non-feasible solutions r̅ᵢ over time. The model 508 can be informed that the non-feasible solutions should not be considered by attributing a low probability of occurrence at the loss function 426. This allows the model 508 to be retrained and redeployed.

The model 508 can be continuously improved by the fine-tuning (e.g., retraining) that is performed using the non-feasible solutions. This is useful when the initial training set is not totally representative due to the vast size of the solution space. Plus, other edge nodes that use the model may solve similar combinatorial optimization problems and will have updated information about the feasible solutions encoded into the updated model 508.

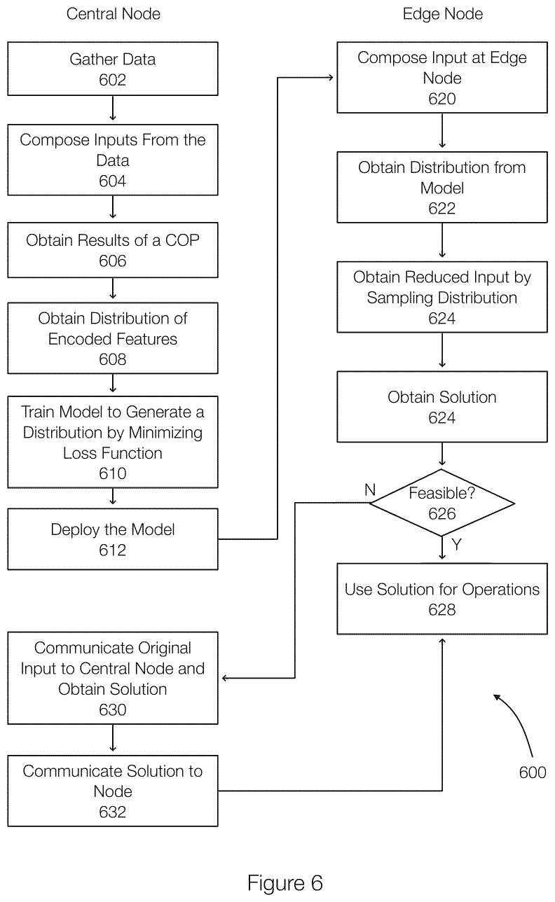

FIG. 6 discloses aspects of solving combinatorial optimization problems including training a model, deploying the model, and generating smaller input sets and smaller sized combinatorial optimization problems. The method 600 illustrates aspects of embodiments of the invention performed at or by a central node and aspects of embodiments of the invention that may be performed by or at the edge nodes.

The method 600, during training, may gather 602 data from the edge nodes at the central node. Generally, this includes collecting unstructured data from each of the edge nodes and storing the collected data in a database.

Next, inputs Xᵢ to the combinatorial optimization problem are composed 604 from the collected data. The manner in which the data is composed or encoded may depend on the type of combinatorial problem being solved. Next the results rᵢ are obtained 606 to the combinatorial optimization problem and a distribution of encoded features of the combinatorial optimization problem is obtained 608.

The distribution of the encoded features, which is a probability distribution in one example, is empirical and derived from solving a non-reduced combinatorial optimization problem. Further, the results or output of the combinatorial optimization problem are optimal results in one example. As previously stated, solving this type of problem at the edge node may not be possible and is therefore performed at the central node.

Once the empirical distribution is obtained 606, a model is trained 610. The model is trained using the empirical distribution, the historical input Xᵢ, and a codification of the combinatorial optimization problem. Using the empirical distribution as ground truth, a loss function allows the model to be trained in a manner that minimizes the loss, which is a difference between the ground truth distribution and the encoded distributions generated by the model.

Once the model is trained, the model is deployed 612 to the edge nodes. Once deployed, to the node, input to the model is composed 620 at the edge node. This input is similar to the input composed at 604. This input is input to the trained model and an encoded distribution is obtained 622 from the model.

The encoded distribution is sampled 624 to compose an input X_{i,k}′, which is a valid input to the reduced size combinatorial optimization problem Oᵢ′, but one which defines a smaller instance of the combinatorial optimization problem.

Using the solving from the reduced-size combinatorial optimization problem using the reduced input, a solution to the reduced size combinatorial optimization problem is obtained 624. If the solution is feasible (Y at 626), the solution is used for operations 628 of the edge node. If the solution is not feasible (N at 626), the original input X_{i,k} is communicated to a central node and an optimal solution is generated by the central node 630. In other words, the combinatorial optimization problem Oᵢ is solved with X_{i,k}. This solution r_{i,k} is communicated 632 back to the node and used 628 by the node for operational purposes. The non-feasible solutions are incorporated when retraining the model as necessary.

The resolution of a combinatorial optimization problem that one edge node εᵢ could not solve by itself given its restricted computational capability is resolved by a reduced size combinatorial optimization problem using reduced input. In this aspect, given a machine learning model and an encoding process for the size of the problem, each node can optimize its own combinatorial optimization problem, thus, reducing drastically the dependency on the central node [symbol] with possible bottleneck formation.

Reducing the size of a combinatorial optimization problem to a manageable size has many advantages. This mitigates or reduces communication requirements between a central node and multiple edge nodes. If edge nodes are unable to solve combinatorial optimization problems, all edge nodes may send these problems to the central node and expect a quick resolution, which is unlikely. A queue of combinatorial optimization problems may create a bottleneck and increase the average response time between each edge node and the central node or server. The ability to generate a solution using a reduced size combinatorial optimization problem mitigates these communication requirements. In other words, communication overhead with the central node or server is reduced.

The mode is also improved or retrained using feedback (e.g., non-feasible solutions) to fine tune the model. As non-feasible solutions are communicated to the central node, subsequent trainings allow what is learned from the non-feasible solutions to be incorporated into the retrained model.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, operations which may include, but are not limited to, combinatorial optimization operations, machine learning operations, loss minimization operations, model retraining operations, combinatorial problem size reduction operations, or the like. More generally, the scope of the invention embraces any operating environment in which the disclosed concepts may be useful.

New and/or modified data collected and/or generated in connection with some embodiments, may be stored in an environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data components such as databases, storage servers, storage volumes (LUNs), storage disks, and servers, for example, may likewise take the form of software, physical machines, containers or virtual machines (VMs), though no particular component implementation is required for any embodiment.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method comprising: gathering data from nodes operating in an environment at a central node, the data including telemetry data, composing, at the central node, inputs from the data, solving a set of combinatorial optimization problem at the central node using the inputs to generate an empirical distribution of input features, training a model at the central node to generate an encoded distribution using a loss function by minimizing a difference between the empirical distribution and the encoded distribution output by the model, and deploying the model to the nodes from the central node.

Embodiment 2. The method of embodiment 1, further comprising training the model based on a codification of the combinatorial optimization problem that is input to the model.

Embodiment 3. The method of embodiment 1 and/or 2, wherein the inputs are based on information from one or more of the nodes.

Embodiment 4. The method of embodiment 1, 2, and/or 3, wherein the nodes share an operational context.

Embodiment 5. The method of embodiment 1, 2, 3, and/or 4, further comprising generating results that include an optimal solution to the combinatorial optimization problem at the central node.

Embodiment 6. The method of embodiment 1, 2, 3, 4, and/or 5, further comprising receiving non-feasible solutions from one or more of the nodes.

Embodiment 7. The method of embodiment 1, 2, 3, 4, 5, and/or 6, further comprising receiving an input from the nodes from which the non-feasible solutions were received, wherein the central node is configured to determine an optimal solution and return the optimal solution to the nodes from which the non-feasible solutions were received.

Embodiment 8. The method of embodiment 1, 2, 3, 4, 5, 6, and/or 7, wherein the model enables the nodes to generate a reduced size combinatorial optimization problem that is smaller than the combinatorial optimization problem.

Embodiment 9. The method of embodiment 1, 2, 3, 4, 5, 6, 7, and/or 8, wherein inputs at the nodes are reduced in size by fixating some of the decision variables, wherein the reduced size combinatorial optimization problem has a smaller search space than the combinatorial optimization problem.

Embodiment 10. A method comprising: receiving a model, at a node, that has been trained at a central node and is configured to generate an encoded distribution, wherein the model was trained using empirical distributions generated from results of a combinatorial optimization problem from historical data, composing an input from data collected at the node, obtaining the encoded distribution for the input using the model, generating a reduced input by sampling the encoded distribution, providing the reduced input to a reduced size combinatorial optimization problem to generate a result, and using the result for operations of the node when the result is feasible.

Embodiment 11. The method of embodiment 10, further comprising sending the input to the central node when the result is non-feasible and receiving an optimal result from the central node, wherein the central node generates the optimal result by solving the combinatorial optimization problem using the input that generated the non-feasible result at the node.

Embodiment 12. A method for performing any of the operations, methods, or processes, or any portion of any of these, or any combination thereof disclosed herein.

Embodiment 13. A non-transitory storage medium having stored therein instructions that are executable by one or more hardware processors to perform operations comprising the operations of any one or more of embodiments 1-13.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. The nodes in an environment may comprise a computer and the central node may comprise a computer.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, agent, engine, or client may refer to software objects or routines that execute on the computing system. The different components, modules, engines, agents, and clients and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

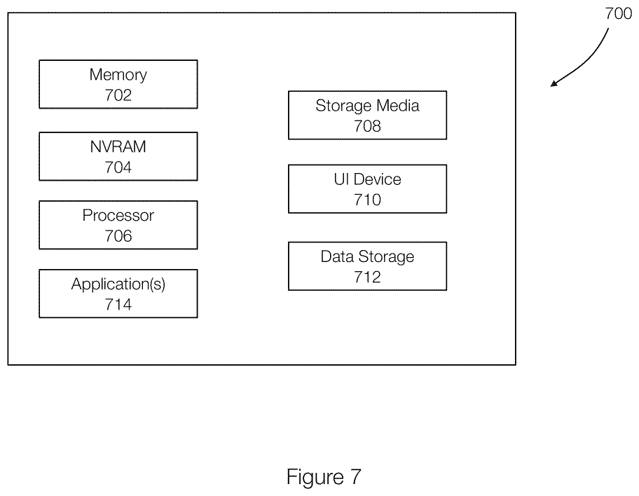

With reference briefly now to FIG. 7, any one or more of the entities disclosed, or implied, by the Figures, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random-access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid-state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
gathering data from nodes operating in an environment at a central node, the data including telemetry data;
composing, at the central node, inputs from the data;
solving a set of combinatorial optimization problems at the central node using the inputs to generate an empirical distribution of input features;
training a model at the central node to generate an encoded distribution using a loss function by minimizing a difference between the empirical distribution and the encoded distribution output by the model; and
deploying the model to the nodes from the central node.

2. The method of claim 1, further comprising training the model based on a codification of the combinatorial optimization problem that is input to the model.

3. The method of claim 1, wherein the inputs are based on information from one or more of the nodes.

4. The method of claim 3, wherein the nodes share an operational context.

5. The method of claim 1, further comprising generating results that include an optimal solution to the combinatorial optimization problem at the central node.

6. The method of claim 1, further comprising receiving non-feasible solutions from one or more of the nodes.

7. The method of claim 6, further comprising receiving an input from the nodes from which the non-feasible solutions were received, wherein the central node is configured to determine an optimal solution and return the optimal solution to the nodes from which the non-feasible solutions were received.

8. The method of claim 1, wherein the model enables the nodes to generate a reduced size combinatorial optimization problem that is smaller than the combinatorial optimization problem.

9. The method of claim 8, wherein inputs at the nodes are reduced in size by fixating some of the decision variables, wherein the reduced size combinatorial optimization problem has a smaller search space than the combinatorial optimization problem.

10. A non-transitory storage medium having stored therein instructions that are executable by one or more hardware processors to perform operations comprising:
gathering data from nodes operating in an environment at a central node, the data including telemetry data;
composing, at the central node, inputs from the data;
solving a set of combinatorial optimization problem at the central node using the inputs to generate an empirical distribution of input features;
training a model at the central node to generate an encoded distribution using a loss function by minimizing a difference between the empirical distribution and the encoded distribution output by the model; and
deploying the model to the nodes from the central node.

11. The non-transitory storage medium of claim 10, further comprising training the model based on a codification of the combinatorial optimization problem that is input to the model.

12. The non-transitory storage medium of claim 10, wherein the inputs are based on information from one or more of the nodes.

13. The non-transitory storage medium of claim 12, wherein the nodes share an operational context.

14. The non-transitory storage medium of claim 10, further comprising generating results that include an optimal solution to the combinatorial optimization problem at the central node.

15. The non-transitory storage medium of claim 10, further comprising receiving non-feasible solutions from one or more of the nodes.

16. The non-transitory storage medium of claim 15, further comprising receiving an input from the nodes from which the non-feasible solutions were received, wherein the central node is configured to determine an optimal solution and return the optimal solution to the nodes from which the non-feasible solutions were received.

17. The non-transitory storage medium of claim 10, wherein the model enables the nodes to generate a reduced size combinatorial optimization problem that is smaller than the combinatorial optimization problem.

18. The non-transitory storage medium of claim 10, wherein inputs at the nodes are reduced in size by fixating some of the decision variables, wherein the reduced size combinatorial optimization problem has a smaller search space than the combinatorial optimization problem.

19. A method comprising:
receiving a model, at a node, that has been trained at a central node and is configured to generate an encoded distribution, wherein the model was trained using empirical distributions generated from results of a combinatorial optimization problem from historical data;
composing an input from data collected at the node;
obtaining the encoded distribution for the input using the model;
generating a reduced input by sampling the encoded distribution;
providing the reduced input to a reduced size combinatorial optimization problem to generate a result; and
using the result for operations of the node when the result is feasible.

20. The method of claim 19, further comprising sending the input to the central node when the result is non-feasible and receiving an optimal result from the central node, wherein the central node generates the optimal result by solving the combinatorial optimization problem using the input that generated the non-feasible result at the node.
